(19) United States
(12) Patent Application Publication
(10) Pub. No.: US 2017/0214535 A1
(43) Pub. Date: Jul. 27, 2017

(54) METHODS AND APPARATUSES OF SERVICE FUNCTION CHAIN BASED ON PCC ARCHITECTURE

(71) Applicant: Alcatel Lucent, Boulogne Billancourt (FR)

(72) Inventors: Xiangyang Li, Shanghai (CN); Laurent Thiebaut, Nozay (FR)

(73) Assignee: Alcatel Lucent, Boulogne Billancourt (FR)

(21) Appl. No.: 15/329,005

(22) PCT Filed: Jul. 9, 2015
(86) PCT No.: PCT/IB2015/001532

§ 371 Date: Jan. 25, 2017

(30) Foreign Application Priority Data
Jul. 25, 2014 (CN) 201410360826.9

(51) Int. Cl. H04L 12/14; H04M 15/00; H04L 29/06

(52) U.S. Cl. CPC H04L 12/1407; H04L 69/22; H04M 15/64; H04M 15/65; H04W 88/16

(57) ABSTRACT

The present invention provides a control method and apparatus of service a function chain based on PCC architecture, the method includes receiving policy rule information of an IP flow from PCRF, the policy rule information includes at least service function chain information; and adding policy rule information header in the uplink IP packet of the IP flow from user side. Based on the policy rule information, the service function execution unit performs service functions for the uplink IP packet and transmits to SFCEF unit the uplink IP packet in which the service functions have been executed. SFCEF unit deletes and stores the policy rule information header, SFCEF unit may be an independent entity or may be integrated in PGW. Similar method applies to a downlink IP packet of the corresponding IP flow. The technical solution of the present application enables service function chain to be updated dynamically, and also provides capability of defining more flexible tariff and business charging model for operators.

### FIELD OF THE PRESENT INVENTION

The present invention relates to a mobile service, and particularly to control method and apparatus of a service function chain based on Policy and Charging Control (PCC) architecture.

### BACKGROUND OF THE PRESENT INVENTION

According to 3GPP EPC specifications (e.g., 3GPP TS 23.401, 23.402), user traffic exchanged by a 3GPP UE over a mobile access network is encapsulated in specific tunnels and is terminated at the Packet Data Network Gateway (PGW), which transmits the user traffic to the Packet Data Network (PDN) via the Gi or SGi interface. But in the real deployments, user traffic is not directly exchanged between PGW and PDN. In most cases, the user traffic passes a set of service functions or valued added services via the so-called “SGi-LAN” between PGW and the PDN. The same kind of deployment applies to user traffic of wired line, the user traffic of wired line is forced to pass a set of service functions or valued added services between Broadband Network Gateway (BNG) and the PDN.

Both the explosion of mobile traffic and the new valued added services deployed at SGi-LAN to optimize traffic and to improve user experience, cause an increase to the number (and to the cost) of functions required in the SGi-LAN. Currently, the deployment model with network service functions are always statically inserted on the data path between PGW and PDN or on the data path between BNG and PDN. If there is a different model which enables that service functions are not required to reside on the default data path and traffic is instead steered through services, it will be very beneficial.

In some cases, a service function needs to be always in the data path but should only be active when some specific conditions are met. For example, video optimizers are inserted in the path of the TCP traffic between the terminal and the content delivery server but become “active” (enforce video optimization) only when the terminal is served by a low throughput radio access (2G or 3G) or by a congested radio access. In this case, the service function needs to be informed when it should be active.

Furthermore, current specifications do not allow charging entities to be made aware about which elements of the SGi service chain have handled the user traffic.

Currently, operators deliver value added services using a static service chain that is determined based on the Access Point Network (APN) for mobile (wireless) networks and based on the subscriber category for wired (fixed) line networks. The list of services applying to the user traffic is “hard-wired” at the level of global forwarding rules enforced at network layer (e.g. Layer 2 or layer 3 forwarding rules based on the APN), which means there is no flexibility of e.g. adding, removing service nodes, or of (re) programming service chains per service data flow. This requires a “handcrafted” operation to manage and maintain the SGi (service) network with a high complexity and cost and delay in service deployment.

In general, it is required to decide which services functions have to handle an IP flow based on varying and flexible conditions, those conditions include at least one of the following items: time of the day, the individual subscription (static insertion of SGi service platforms is controlled by the APN), congestion status of the network, and the application carried by an IP flow.

With Software Defined Radio (SDN) and Network Function Virtualization (NFV) evolution, the development cycle of mobile product is speeding up and the flexibility of the mobile product is improved, operators are expecting that service chaining environments are allowed to be created or modified in a very flexible and simple manner. Thus, the traditional static service delivery mode cannot meet the requirements form operator anymore.

On the other hand, it is necessary to provide input information to service policy of some service functions (SFs). For example, input information on whether the service functions should remain passive or become active, and when to provide active information for the service functions to determine the degree of service enforcement (e.g. the degree of video compression that a service function should apply). Providing such information should not require a deployment of a dedicated control plane interface (e.g., 3GPP Sd interface between PCRF and an Application Detection Function (ADF)/Traffic Detection Function (TDF)) because deploying such interfaces has an operational cost and raises network scaling issues.

### SUMMARY OF THE PRESENT INVENTION

The invention provides a policy-based control method and apparatus of service function chain for PCC architecture. The basic concept lies in that Policy and Charging Rules Function (PCRF) determines policy rules of service function based on the varying and flexible conditions, and transmits the policy rules to PGW/FDT, online charging system (OCS) and offline charging system (OFCS). Based on the policy rules, PGW/TDF adds and/or deletes a header, OCS and OFCS performs corresponding charging functions. In the present invention, the policy rule information is included in the OCS and OFCS (from PCEF in PGW/BNG or from TDF) interfaces, thus, the charging system is able to adopt different tariffs based on the actual used service function chain. This also provides the capability of defining more flexible tariffs and business charging models for operators.

According to a first aspect of the present application, there is provided a control method of a service function chain based on the PCC architecture, the method comprising the steps, performed by a first network device, of: A. receiving policy rule information of an IP flow from a third network device, the policy rule information including service function chain information; B. receiving an uplink packet of the IP flow from a UE, and adding policy rule information header in the uplink packet of the IP flow; and C. transmitting, based on the policy rule information, to a service function execution unit, the uplink IP packet in which the policy rule information header has been added; the service function execution unit being configured for performing all service functions in the policy rule information for the uplink IP packet in which the policy rule information header has been added, and transmitting, to a second network device, the uplink IP packet in which all service functions have been performed.

According to one embodiment of the present application, further comprising after the step C: D. receiving a downlink IP packet of the IP flow in which all service functions have been performed, and deleting policy rule information in the downlink IP packet.

According to one embodiment of the present application, further comprising after the step B: an online charging procedure or an offline charging procedure.

According to one embodiment of the present application, further comprising prior to the step D: an online charging procedure or an offline charging procedure.

According to one embodiment of the present application, the online charging procedure comprises the steps of: E. transmitting, to an online charging system, an online charging request of the service function chain information, the online charging request including the service function chain information; and F. receiving, from an online charging system, an online charging reply; the offline charging procedure comprising the steps of: H. transmitting, to an offline charging system, an offline charging request of the service function chain information, the offline charging request including the service function chain information; and I. receiving, from an offline charging system, an offline charging reply.

According to one embodiment of the present application, the service function chain information comprises an ordered set of all service functions of the IP flow.

According to one embodiment of the present application, the policy rule information further comprises a policy input of a service function, the policy input of a service function provides input information for a service function in the service function chain.

According to one embodiment of the present application, the first network device is PDN gateway or traffic detection function or broadband network gateway control device.

According to a second aspect of the present application, there is provided a control method of a service function chain based on the PCC architecture, the method comprising the steps, performed by a second network device, of: receiving, from a service function execution unit, an uplink IP packet of an IP flow; deleting policy rule information in the uplink IP packet, and storing the policy rule information, wherein the policy rule information includes service function chain information; and transmitting, to a PDN, the uplink IP packet in which the policy rule information is deleted.

According to one embodiment of the present application, further comprising: receiving, from the PDN, a downlink IP packet of the IP flow; retrieving the policy rule information and adding a policy rule information header in the downlink IP packet from the PDN; transmitting, based on the policy rule information, the downlink IP packet in which the policy rule information header has been added, the service function execution unit being configured for performing all service functions in the policy rule information for the downlink IP packet and transmitting the downlink IP packet in which all service functions have been performed, to a first network device.

According to one embodiment of the present application, the service function chain information comprises an ordered set of all service functions of the IP flow.

According to one embodiment of the present application, the policy rule information further comprises a policy input of a service function, the policy input of a service function providing input information for a service function in the service function chain.

According to one embodiment of the present application, the second network device is a service function edge chain function unit and the second network device is integrated in a first network device or is an independent entity.

According to a third aspect of the present application, there is provided a control method of a service function chain based on the PCC architecture, the method comprising the steps, performed by a third network device, of: i. determining a policy rule of an IP flow; ii. transmitting, to a first network device, policy rule information of the policy rule, the policy rule information including service function chain information.

According to one embodiment of the present application, the service function chain information comprises an ordered set of all service functions of the IP flow.

According to one embodiment of the present application, wherein the policy rule information further comprises a policy input of a service function, the policy input of a service function providing input information for a service function in the service function chain.

According to one embodiment of the present application, wherein the step i further comprises: determining, based on at least one of conditions, a policy rule, wherein the conditions includes time period, application flow information, application sponsorship information, network information, subscriber information, subscriber charging information and operator policy.

According to a fourth aspect of the present application, there is provided a first control apparatus of a service function chain based on the PCC architecture, the first control apparatus comprising: a receiving unit for receiving policy rule information of an IP flow from a third network device, the policy rule information including service function chain information; an adding unit for receiving an uplink packet of the IP flow from a UE, and adding a policy rule information header in the uplink packet of the IP flow; and a transmitting unit for transmitting, based on the policy rule information, to a service function execution unit, the uplink packet in which an policy rule information header has been added; the service function execution unit being configured for performing all service functions in the policy rule information for the uplink IP packet in which the policy rule information header has been added, and transmitting the uplink IP packet in which all service functions have been performed to a service function chain edge unit; a deleting unit for receiving a downlink IP packet of the IP flow in which all service functions have been performed, and deleting policy rule information in the downlink IP packet.

According to one embodiment of the present application, further comprising: an online charging unit for transmitting, to an online charging system, an online charging request of the service function chain information and receiving an online reply from an online charging system, the online charging request includes the service function chain information; an offline charging unit for transmitting, to an offline charging system, an offline charging request of the service function chain information and receiving, from an offline charging system, an offline charging reply, the offline charging request including the service function chain information.

According to one embodiment of the present application, the service function chain information comprises an ordered set of all service functions of the IP flow.

According to one embodiment of the present application, the policy rule information further comprises a policy input of a service function, the policy input of a service function providing input information for a service function in the service function chain.

According to a fifth aspect of the present application, there is provided a second control apparatus of a service function chain based on the PCC architecture, the second control apparatus comprising: a receiving unit for receiving, from a service function execution unit, an uplink IP packet of an IP flow and receiving, from PDN, a downlink IP packet of the IP flow; a deleting and storing unit for deleting policy rule information in the uplink IP packet, and storing the policy rule information, wherein the policy rule information includes service function chain information; and an adding unit for retrieving the policy rule information and adding the policy rule information header in the downlink IP packet from the PDN; a transmitting unit for transmitting, to the PDN, the uplink IP packet in which the policy rule information is deleted and transmitting, based on the policy rule information, the downlink IP packet in which the policy rule information header has been added; wherein the service function execution unit being configured for performing all service functions in the policy rule information and transmitting the downlink IP packet in which all service functions have been performed, to a first network device.

According to one embodiment of the present application, the second control apparatus is a service function edge chain function unit, the second network device is integrated in a first network device or is an independent entity.

According to a sixth aspect of the present application, there is provided a third control apparatus of a service function chain based on the PCC architecture, the third control apparatus comprising: a determination unit for determining a policy rule of an IP flow; a transmitting unit for transmitting, to a first network device, policy rule information of the policy rule, the policy rule information including at least service function chain information.

The solution of the present application enables operator to optimize service delivery, offers value-added service based on network, optimize network behavior (protect network against attacks and ensure privacy). The policy-based technical solution of service chain function in the present application enhances the existing 3GPP LTE/EPS architecture, enhances the policy control in supporting dynamic service function chain enables the operator to generate more revenue from IP traffic flow, and provides better service over the traditional IP service. Therefore, it is very important to a mobile operator.

Various aspects of the present application will become more apparent through the description of embodiments hereinafter.

### BRIEF DESCRIPTION OF THE DRAWINGS

The other features and advantages of the present invention will be better understood via the preferable embodiments described in detail hereinafter with reference to the accompanying drawings.

FIG. 1 illustrates a schematic view of the policy-based service function chain;

FIG. 2 illustrates a flow chart of uplink call according to an embodiment of the invention;

FIG. 3 illustrates a flow chart of downlink call corresponding to FIG. 2;

FIG. 4 illustrates a flow chart of uplink call according to another embodiment of the invention;

FIG. 5 illustrates a flow chart of downlink call corresponding to FIG. 4;

FIG. 6 illustrates a schematic view of a first control apparatus of the service function chain based on PCC architecture;

FIG. 7 illustrates a schematic view of a second control apparatus of the service function chain based on PCC architecture; and

FIG. 8 illustrates a schematic view of a third control apparatus of the service function chain based on PCC architecture.

In the figures, the same or similar reference number indicates the same or similar component or feature.

### DETAILED DESCRIPTION OF THE PREFERRED EMBODIMENTS

In detailed description of the preferred embodiment hereafter, appended figures, as part of the present application, will be referred. The appended drawings illustrate the specific embodiments to carry out the present application through exemplary manner. Exemplary embodiments are not intended to exhaust all embodiments of the present application. It needs to clarify that, although steps associated with corresponding method in the present application is described in a specific order in accompanying drawings, it does not requires or suggests that those operations must be performed accordance with the specific order, or all the illustrated operations must be performed in order to achieve the desired results, in contrast, the order described in the present application can be changed. Additionally or alternatively, some steps may be omitted, multiple steps may be combined into one step, and/or one step may be decomposed into several steps.

For better describing the technical solution of the present application, some terms of the present application are defined.

PGW: PGW terminates the SGi interface to external data networks (e.g. Internet, IMS etc.), is responsible for managing data routine between 3GPP and non-3GPP and for managing mobility between 3GPP access and non-3GPP access (e.g., WLAN, WiMAX etc.), and is also responsible for functions like DHCP, policy enforcement and charging.

PCRF: PCRF is a policy decision node for the policy of traffic data flow and IP bearing resource and charging control policy, it selects and provides the available policy and charging control policy decision for Policy and Charging Execution Function (PCEF) unit.

PCEF: It mainly includes the detection, policy enforcement and flow-based charging function of traffic data flow. This function entity is located in the gateway, e.g., GGSN Gateway of GPRS, P-GW of EPC, PDG of WLAN, or is independently deployed.

Service Function Chain: It defines required corresponding service functions and an order for performing the service functions (SF1->SF2).

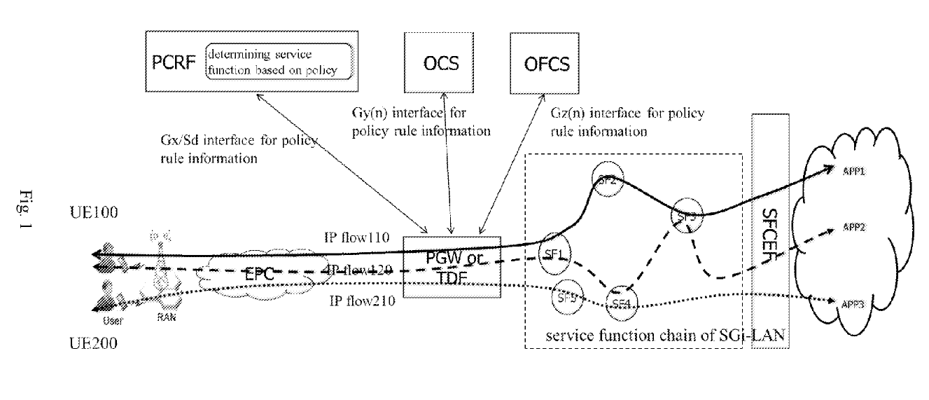

FIG. 1 illustrates a schematic view of the policy-based service function chain. As shown in FIG. 1, PGW or TDF provides policy rule to PCRF, OCS and OFCS via Gx/Sd, Gy(n) and Gz(n) interface, respectively.

PCEF enhanced ADC or TDF sends an online charging request including policy rule information to OCS via Gy or Gyn, so the online charging system can apply different tariffs to the application service data flow, based on the different service functions that have handled the user traffic.

Similarly, for offline charging, the PCEF enhanced with ADC or TDF sends the offline charging request including policy rule information to OFCS to generate the CDR via Gz or Gzn, so the OFCS can use the service chain function for postpaid billing, revenue assurance, reporting and analysis etc.

UE 100 initiates two service data flows: IP Flow 110 and IP Flow 120 for APP1 and APP 2 respectively, UE 200 initiates one service data flow IP 210 for APP 2. PCRF based on the policy rule derives the following service chains.

For UE 100:
The service chain for IP Flow 110: SF1->SF2->SF3
The service chain for IP Flow 120: SF1->SF4->SF3

For UE 200:
The service chain for IP Flow 210: SF5->SF4.

PCRF determines policy rule based on varying and flexible conditions. The policy rule includes service chain information that includes an ordered set of all service chain of the IP flow. Alternatively, besides the service function chain information, the policy rules may further include policy input of the service chain function that provides input to service functions in the service function chain. Specifically, service function chain information may define service function ID and service function list. The service function list further defines the execution order and the priority of the service functions, and may be made up of service function ID and service function locator. The service function locator is the IP address for the specific service function ID.

If PCRF does not provide policy rule information, Service Function Chain Edge Function (SFCEF) may determine service function chain based on the default policy rule information of local configuration in PGW/TDF.

PCRF determines the service chain and policy input of the service functions based on the following conditions and information, these conditions and information may include:
Time of the day;
Application flow information (layer 3 to layer 7) and application sponsorship information;
Network information: Subscriber radio access and location information, Quality of Service (QoS), network congestion status etc.
Subscriber repository context: subscriber allowed valued added service, service priority, sub scriber allowed QoS, sub scriber category (enterprise, personal-adult/young etc.), age, birthday etc. The subscriber subscription context information can be obtained from subscriber profile repository (SPR) via Sp reference point interface. For example, the teenage users require the parental control valued added service function, and the enterprise users require the enterprise security service function;
Subscriber charging information: e.g. policy based spending counter status, which can be received via the Sy interface with for example, OCS;
Operator policies.

The skilled in the art should appreciate that though policy input of the service functions is listed above, but not limited to those, any other appropriate policy input of the service function chain based on various applications may be adopted in the present application.

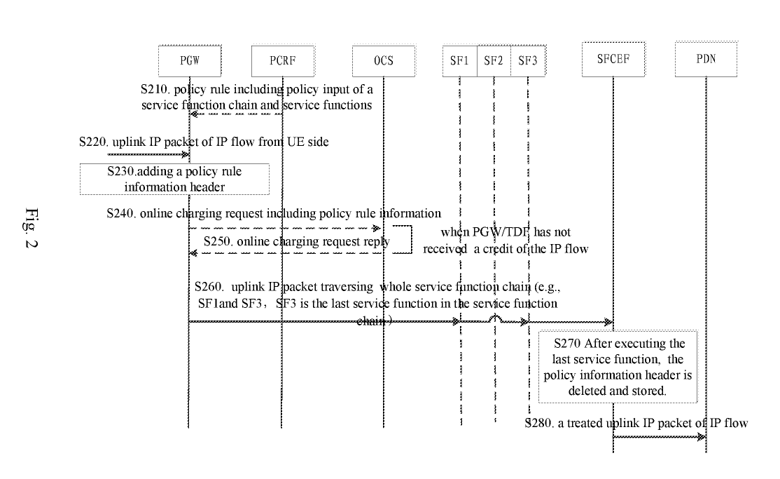

FIG. 2 illustrates a flow chart of uplink call according to an embodiment of the invention. The embodiment of the present application takes PGW as an example to illustrate the technical solution of the present application. The skilled person in the art should appreciate that TDF or BNG or any other appropriate network devices may perform the technical solution of the present application by replacing PGW.

In Step S210 of FIG. 2, PCRF transmits the policy rule information to PGW via Gx/Sd interface, the policy rule information at least include service function chain information that includes an ordered set of all service functions in the IP flow.

Preferably, the policy rule information may further include policy input of the service functions, and the policy input of the service functions is transmitted to service function in the service function chain.

In Step S220, PGW receives an uplink IP packet of the IP flow from user side.

In Step S230, PGW adds the policy rule information header in the uplink IP packet of the IP flow.

PGW has never received a credit of the service function chain, in Step S240, PGW transmits to OCS an online charging request of the service function chain, the online charging request includes the service function information, and the credit refers to a quota assigned by OCS.

In Step S250, OCS transmits an online charging reply to PGW.

Similarly, for OFCS, PGW transmits to OFCS (not shown in FIG. 2) an offline charging request of the service function chain, the offline charging request includes service function chain information, and then OFCS transmits to PGW corresponding offline charging reply.

In Step S260, PGW transmits to service function execution unit (i.e., SF1 and SF 3 in FIG. 2) an uplink IP packet in which policy rule information has been added. Service function execution unit performs service functions in the policy rule information for the uplink IP packet in which the policy rule information has been added, and transmits to SFCEF the uplink IP packet in which all the service functions have been executed. In the embodiment as shown in FIG. 2, SFCEF is an independent entity.

As illustrated in FIG. 2, for example, the service function chain information includes an ordered set of SF1->SF3, SF1 is executed for uplink IP packet firstly, then SF3 is executed for the uplink IP packet, SF3 is the last service function in the service function chain.

In Step S270, SFCEF receives an uplink IP packet of the IP flow from the service function execution unit, deletes the policy rule information in the uplink IP packet, and stores the policy rule information (for further processing of an downlink IP packet of the same IP flow).

In Step S280, SFCEF transmits to PDN the uplink IP packet of the IP flow, in which the policy rule information has been deleted.

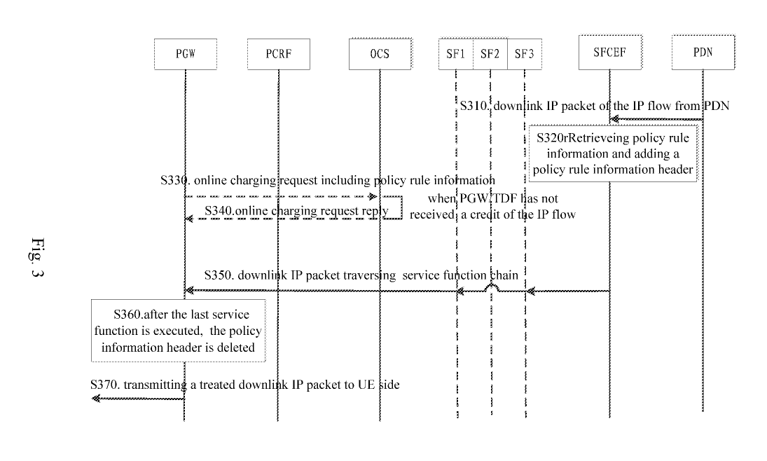

FIG. 3 illustrates a flow chart of downlink call corresponding to FIG. 2.

In Step S310, the SFCEF receives a downlink IP packet of the corresponding IP flow in FIG. 2.

In Step S320, SFCEF determines the corresponding IP flow of the downlink IP packet, and retrieves the policy rule information stored in Step S270, and adds the policy rule information in the downlink IP packet from PDN.

Similarly, in Step S330 and Step S340, PGW needs to initiate corresponding online or offline charging request to OCS or OFCS (not shown in FIG. 3), respectively, which are not repeated here.

In Step S350, based on the policy rule information, SFCEF transmits to service function execution unit the downlink IP packet in which the policy rule information has been added. The service function execution unit executes the service functions in the policy rules information for the downlink IP packet, and transmits to PGW the downlink IP packet in which all service functions have been executed.

In Step S360, PGW receives the downlink IP packet of the IP flow, in which all service functions have been executed, and deletes policy rule information in the downlink IP packet.

For example, after SF1 and SF3 in service function chain have been executed for the downlink IP packet, PGW deletes the policy rule information in the downlink IP packet.

Step S370, PGW transmits to the UE the downlink IP packet of the IP flow.

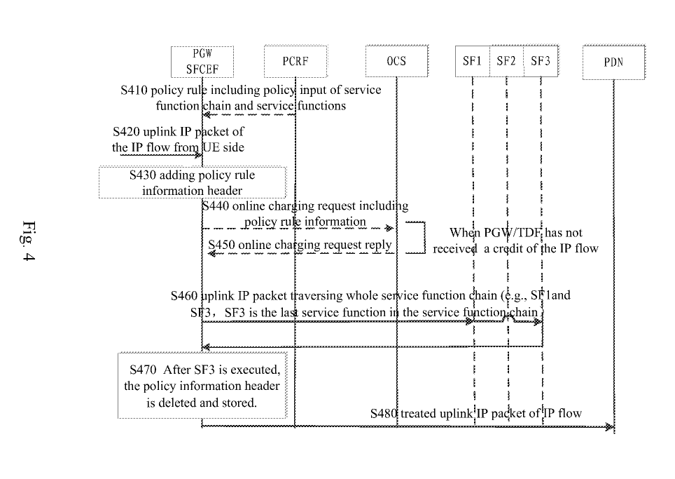

FIG. 4 illustrates a flow chart of uplink call according to another embodiment of the invention, in the embodiment illustrated in FIG. 4, SFCEF unit is integrated in PGW, especially, SFCEF may be integrated in Policy and Charging Enforcement Function (PCEF) in PGW. As the steps in FIG. 4 are similar to Steps S210-S250 in FIG. 2, which are not repeated here.

In Step S460, based on the policy rule information, transmits to service function execution unit (i.e., SF1 and SF3 in FIG. 4) an uplink IP packet in which the policy rule information has been added. Service function execution unit executes the service functions in the policy rule information for the uplink IP packet in which the policy rule information has been added, and transmits to the SFCEF integrated in the PGW the uplink IP packet in which all service functions have been executed, in the embodiment shown in FIG. 4, SFCEF unit is integrated in PGW.

In Step S470, SFCEF integrated in PGW receives the uplink IP packet of the IP flow from service function execution unit, deletes the policy rule information in the uplink IP packet, and stores the policy rule information (for further processing of an downlink IP packet of the same IP flow).

In Step S480, SFCEF integrated in PGW transmits to PDN an uplink IP packet of the IP flow in which the policy rule information has been deleted.

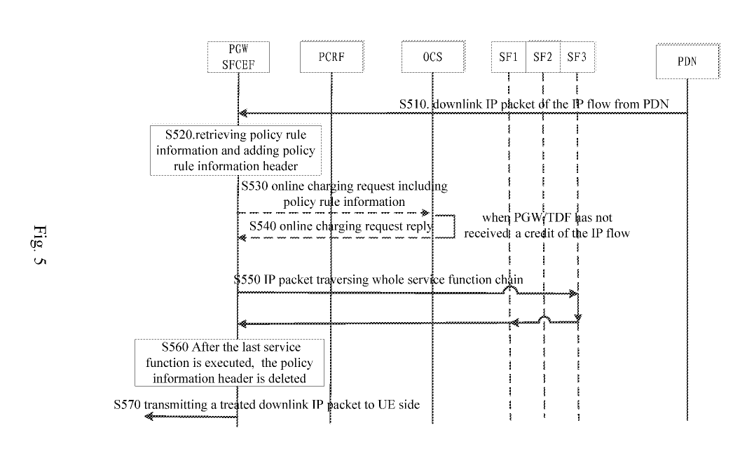

FIG. 5 illustrates a flow chart of downlink call corresponding to FIG. 4, in the embodiment shown in FIG. 5, SFCEF is integrated in PGW. Specially, SFCEF may be integrated in PCEF in PGW.

In Step S510, SFCEF integrated in PGW receives, from PDN, the downlink IP packet of the IP flow corresponding to Step S480.

In Step S520, SFCEF integrated in PGW retrieves the policy rule information and adds the policy rule information header in the downlink IP packet form PDN.

Step S530 and Step S540 about online or offline charging have been described in aforementioned description, which are not repeated here.

In Step S550, based on the policy rule information, SFCEF integrated in PGW transmits to service function execution unit the downlink IP packet in which the policy rule information has been added, the service function execution unit is used for executing service functions in the policy rule information for downlink IP packet, and transmits to PGW the downlink IP packet in which the service functions have been executed.

Step S560 and Step S570 are similar to Step S360 and Step S370 in FIG. 3, respectively, which are not repeated here.

The technical solution of the present application enables PCRF to install, update and delete service information chain information and policy input of service functions at any time, so as to add/modify/delete PCC/ADC rules via Gx/Sd interface. In this way, service function chain may be updated dynamically based on the requirements from operators and UEs.

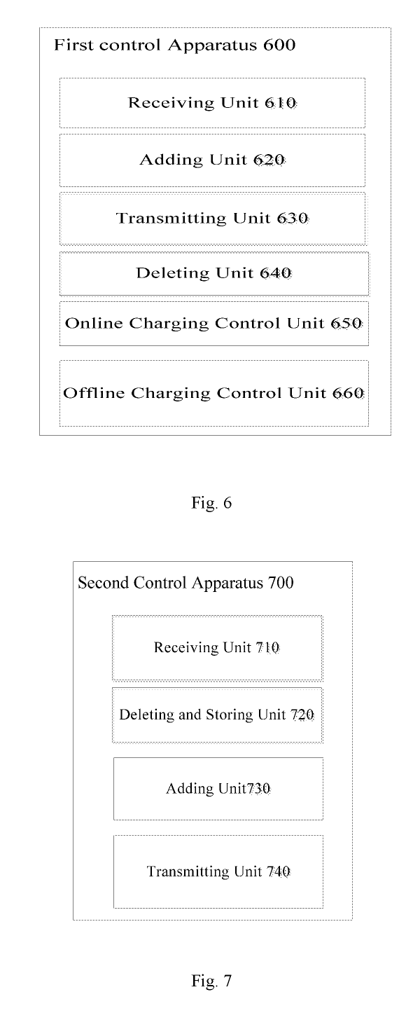

FIG. 6 illustrates a schematic view of a first control apparatus 600 of the service function chain based on PCC architecture. The first control apparatus 600 may be or may implement PWG or TDF or BNG in the embodiment described in the aforementioned description in conjunction with FIGS. 2-5.

As illustrated in FIG. 6, the first control apparatus comprises a receiving unit 610 for receiving policy rule information of an IP flow from a third network device, the policy rule information includes service function chain information; an adding unit 620 for receiving an uplink packet of the IP flow from a UE, and adding policy rule policy information header in the uplink packet of the IP flow; and a transmitting unit 630 for transmitting, based on the policy rule information, to a service function execution unit, the uplink packet which has been added an policy rule information header; the service function execution unit performs all service functions in the policy rule information for the uplink packet which has been added an policy rule information header, and transmits the uplink packet being performed all service functions to a second network device; a deleting unit 640 for receiving a downlink IP packet of the IP flow which has been performed all service functions, and deleting policy rule information in the downlink IP packet.

The first control apparatus further comprises an online charging unit 650 for transmitting, to an online charging system, an online charging request of the service function chain and receiving an online reply from an online charging system, the online charging request includes the service function chain information; an offline charging unit 660 for transmitting, to an offline charging system, an offline charging request of the service function chain and receiving, from an offline charging system, an offline charging reply, the offline charging request comprises the service function chain information.

FIG. 7 illustrates a schematic view of a second control apparatus of the service function chain based on PCC architecture. The second control apparatus 700 may be or may implement SFCEF in the embodiment described in the aforementioned description in conjunction with FIGS. 2-5, which may be an independent entity or may be integrated in PGW.

As illustrated in FIG. 7, the second control apparatus comprises a receiving unit 710 for receiving, from a service function execution unit, an uplink IP packet of an IP flow and receiving, from a PDN, a downlink IP packet of the IP flow; a deleting and storing unit 720 for deleting policy rule information in the uplink IP packet, and storing the policy rule information, wherein the policy rule information includes service function chain information; and an adding unit 730 for retrieving the policy rule information and adding the policy rule information header in the downlink IP packet from the PDN; a transmitting unit 740 for transmitting, to the PDN, the uplink IP packet in which the policy rule information is deleted and transmitting, based on the policy rule information, the downlink IP packet which has been added the policy rule information header to a service function execution unit; wherein the service function execution unit performs all service functions in the policy rule information and transmits the downlink IP packet in which the service function have been performed, to a first network device.

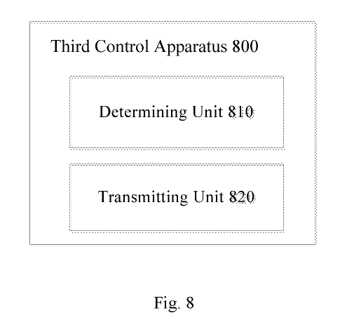

FIG. 8 illustrates a schematic view of a third control apparatus of the service function chain based on PCC architecture. The third control apparatus 800 may be or may implement PCRF in the embodiment described in the aforementioned description in conjunction with FIGS. 2-5, which may be an independent entity or may be integrated in PGW.

As illustrated in FIG. 8, the third control apparatus comprises a determination unit 810 for determining a policy rule of an IP flow; a transmitting unit 820 for transmitting, to a first network device, policy rule information of the policy rule, the policy rule information includes at least service function chain information.

It should be noted that the above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims. In addition, any of the reference numerals in the claims should not be interpreted as a limitation to the claims. Use of the verb “comprise” and its conjugations does not exclude the presence of elements or steps other than those stated in a claim.

1. A control method of a service function chain based on PCC architecture, performed by a first network device, of:
receiving, from a third network device, policy rule information of an IP flow, the policy rule information including service function chain information;
receiving, from a UE, an uplink packet of the IP flow, and adding a policy rule information header in the uplink packet of the IP flow; and
transmitting, based on the policy rule information, to a service function execution unit, the uplink IP packet in which the policy rule information header has been added; the service function execution unit being configured for performing all service functions in the policy rule information for the uplink IP packet in which the policy rule information header has been added, and transmitting, to a second network device, the uplink IP packet in which all service functions have been performed.

2. The control method according to claim 1, further comprising after the transmitting:
receiving a downlink IP packet of the IP flow in which all service functions have been performed, and deleting policy rule information in the downlink IP packet.

3. The control method according to claim 1, further comprising after the receiving, from a UE:
an online charging procedure or an offline charging procedure.

4. The control method according to claim 2, further comprising prior to the receiving a downlink IP packet:
an online charging procedure or an offline charging procedure.

5. The control method according to claim 3,
wherein the online charging procedure comprises:
transmitting, to an online charging system, an online charging request of the service function chain information, the online charging request including the service function chain information; and
receiving, from an online charging system, an online charging reply;
the offline charging procedure comprising:
transmitting, to an offline charging system, an offline charging request of the service function chain information, the offline charging request including the service function chain information; and
receiving, from an offline charging system, an offline charging reply.

6. The control method according to claim 1, wherein the service function chain information comprises an ordered set of all service functions of the IP flow.

7. The control method according to claim 1, wherein the policy rule information further comprises a policy input of a service function, the policy input of a service function provides input information for a service function in the service function chain.

8. The control method according to claim 1, wherein the first network device is PDN gateway or traffic detection function or broadband network gateway control device.

9. A control method of a service function chain based on PCC architecture, performed by a second network device, of:
receiving, from a service function execution unit, an uplink IP packet of an IP flow;
deleting policy rule information in the uplink IP packet and storing the policy rule information, the policy rule information including service function chain information; and
transmitting, to a PDN, the uplink IP packet in which the policy rule information has been deleted.

10. The control method according to claim 9, further comprising:
receiving, from the PDN, a downlink IP packet of the IP flow;
retrieving the policy rule information and adding a policy rule information header in the downlink IP packet from the PDN;
transmitting, based on the policy rule information, the downlink IP packet in which the policy rule information header has been added, the service function execution unit being configured for performs all service functions in the policy rule information for the downlink IP packet and transmitting the downlink IP packet in which all service functions have been performed, to a first network device.

11.-12. (canceled)

13. The control method according to claim 9, wherein the second network device is a service function chain edge function unit and the second network device is integrated in a first network device or is an independent entity.

14. A control method of a service function chain based on PCC architecture, performed by a third network device, of:
determining a policy rule of an IP flow;
transmitting, to a first network device, policy rule information of the policy rule, the policy rule information including service function chain information.

15.-16. (canceled)

17. The control method according to claim 14, wherein the determining further comprises:
determining, based on at least one of conditions, a policy rule, wherein the conditions include time period, application flow information, application sponsorship information, network information, subscriber information, subscriber charging information and operator policy.

18. A first control apparatus of a service function chain based on the PCC architecture, the first control apparatus comprising:
a receiving unit for receiving policy rule information of an IP flow from a third network device, the policy rule information including service function chain information;
an adding unit for receiving an uplink packet of the IP flow from a UE and adding a policy rule information header in the uplink packet of the IP flow; and
a transmitting unit for transmitting, based on the policy rule information, to a service function execution unit, the uplink IP packet in which the policy rule information header has been added; the service function execution unit being configured for performing all service functions in the policy rule information for the uplink IP packet in which the policy rule information header has been added, and transmitting the uplink IP packet in which all service functions have been performed to a service function chain edge function unit;
a deleting unit for receiving a downlink IP packet of the IP flow in which all service functions have been performed, and deleting policy rule information in the downlink IP packet.

19.-21. (canceled)

22. A second control apparatus of a service function chain based on the PCC architecture, the second control apparatus comprising:
a receiving unit for receiving, from a service function execution unit, an uplink IP packet of an IP flow and receiving, from PDN, a downlink IP packet of the IP flow;
a deleting and storing unit for deleting policy rule information in the uplink IP packet, and storing the policy rule information, wherein the policy rule information includes service function chain information; and
an adding unit for retrieving the policy rule information and adding the policy rule information header in the downlink IP packet from the PDN;
a transmitting unit for transmitting, to the PDN, the uplink IP packet in which the policy rule information has been deleted and transmitting, based on the policy rule information, the downlink IP packet in which the policy rule information header has been added to a service function execution unit;
wherein the service function execution unit performs all service functions in the policy rule information and transmits the downlink IP packet in which all service functions have been performed, to a first network device.

23.-24. (canceled)
